(19) United States
(12) Patent Application Publication
(10) Pub. No.: US 2026/0259911 A1
(43) Pub. Date: Sep. 3, 2026

(54) USER INTERFACE BASED ASSISTED CONTENT SEARCHING

(71) Applicant: ADP, Inc., Roseland, NJ (US)

(72) Inventors: Yongmei Jia, Florham Park, NJ (US); Philip Houston, Florham Park, NJ (US)

(73) Assignee: ADP, Inc., Roseland, NJ (US)

(21) Appl. No.: 19/066,826

(22) Filed: Feb. 28, 2025

(51) Int. Cl. G06F 16/334; G06F 40/279; G06F 40/30

(52) U.S. Cl. CPC G06F 16/3347; G06F 40/279; G06F 40/30

(57) ABSTRACT

The technical solutions described herein present a user interface with enhanced assistance content searching combining keyword and semantic search results u. A system can identify a term of a search query input into a user interface of a device and generate keyword search results, based on the term, for display in the user interface. The system can determine to use a semantic search responsive to a parameter of the keyword search results not satisfying a threshold. Responsive to this determination, the system can generate using the semantic search for a vector representation of the one or more terms and vector representations of contents to assist with the search query, one or more semantic search results. The system can provide, for display via the user interface, a combination of the keyword search results and the semantic search results, with the parameter satisfying the threshold.

### TECHNICAL FIELD

The present patent application generally relates to assistance for content searching, and more particularly to machine learning based user search assistance solutions using keyword and semantic searches.

### BACKGROUND

In the realm of enterprise operations, computing systems can provide a wide range of applications and services for a variety of enterprise users. As computing systems utilize various user interfaces to provide computational services and operations, it can be challenging for a system to timely provide adequate helpful content to users seeking assistance.

Technical solutions described herein provide user interface solutions with enhanced assistance content using machine learning to combine keyword and semantic search results. A client device, which can be an electronic communication device, can be used to generate and input a search query into a computing system, such as an enterprise system. Several existing technologies facilitate providing assistance content (e.g., help resources or support links) while the search query is being input via the client device’s interface. When providing such assistance content, traditional keyword search techniques can become too specific, especially as the number of terms in the search query increases. This specificity can result in fewer or no keyword search results being generated as the search query becomes too long or too detailed to identify any matching content. Consequently, the assistance content window may display an insufficient number of links to relevant applications or materials, rendering the feature unsuitable for its intended purpose of providing helpful content, via the user interface, to the user entering the search query. This can be particularly challenging in environments where users rely on quick and accurate access to assistance content, such as in customer support systems, knowledge bases, or digital assistants.

The technical solutions described herein overcome such technical challenges by utilizing machine learning to provide assistance content search results via a combination of keyword and semantic search results. For example, the technical solutions facilitate a system to provide a user interface that includes an assistance content window to display results of an integration of both keyword and semantic search techniques. Accordingly, the technical solutions enhance the relevance and quality of search results displayed to the user. The system can identify search terms input into the user interface and generate keyword search results based on the search terms. If the keyword search results do not satisfy a threshold parameter (e.g., a minimum number of search results to display, a sufficient quality threshold for the search results, etc.), the system can determine to utilize a semantic search to supplement the keyword search results. The system can utilize machine learning to generate vector representations of the search terms and compare the vector representations of the search terms with the vector representations of various assistance content materials. By combining the keyword search results and semantic search results, the system can provide an improved set of results in the assistance content window. In doing so, the technical solutions provide more accurate and contextually relevant assistance content regardless of the search query length or specificity, thereby maintaining a desired number of displayed search results while improving the overall user experience and efficiency in accessing information.

An aspect of the technical solutions is directed to a system. The system can include one or more processors, coupled with memory. The one or more processors can be configured (e.g., via instructions and data stored in memory) to identify one or more terms of a search query input into a user interface of a device. The one or more processors can be configured to generate, for display in the user interface using a keyword search, one or more keyword search results based on the one or more terms. The one or more processors can be configured to determine to use a semantic search responsive to a parameter of the one or more keyword search results not satisfying a threshold for results to display in the user interface, wherein the semantic search is different from the keyword search. The one or more processors can be configured to generate, responsive to the determination and using the semantic search for a vector representation of the one or more terms and vector representations of contents to assist with the search query, one or more semantic search results. The one or more processors can be configured to provide, for display via the user interface of the device, a combination of at least one of the one or more of the keyword search results and at least one of the one or more of the semantic search results, wherein the parameter of the combination satisfies the threshold.

The parameter can correspond to a number of the one or more keyword search results generated using the keyword search. The one or more processors can be configured to determine that the parameter does not satisfy the threshold based on a comparison of the parameter and a number of results of the combination to include in the assistance content window. The parameter can correspond to a level of quality of the one or more keyword search results. The level of quality can be determined based on a similarity search between the one or more terms and the one or more keyword search results. The one or more processors can be configured to determine that the parameter does not satisfy the threshold in response to a comparison of the parameter and the level of quality.

The one or more processors can be configured to identify one or more machine learning models trained to generate vector representations of summaries of the contents to assist with search queries. The one or more processors can be configured to generate, using the contents to assist input into the one or more machine learning models, data structures of summaries of the contents to assist. The one or more processors can be configured to generate, using the data structures input into the one or more machine learning models, vector representations of the contents to assist. The contents to assist can include at least one of a web page associated with one or more services to be provided via the user interface or a document associated with the one or more services to be provided via the user interface. The data structures can include one or more JavaScript Object Notation (JSON) data structures.

The one or more processors can be configured to receive, via a first portion of the user interface for receiving the search query, a first term of the one or more terms of the search query prior to receiving a second term of the one or more terms. The one or more processors can be configured to generate, for display in a second portion of the user interface for presenting contents to assist, prior to receiving the second term via the user interface, the one or more keyword search results based on the first term of the one or more terms. The one or more processors can be configured to provide, for display via the second portion of the user interface, prior to receiving the second term via the user interface and based on the first term, the combination of the at least one of the one or more of the keyword search results and the at least one of the one or more of the semantic search results.

The one or more processors can be configured to receive, via the first portion of the user interface, the second term of the search query. The one or more processors can be configured to generate, for display in the second portion of the user interface, the one or more keyword search results based on the first term and the second term. The one or more processors can be configured to provide, for display via the second portion of the user interface based on the first term and the second term, the combination of the at least one of the one or more of the keyword search results and the at least one of the one or more of the semantic search results.

The one or more processors can be configured to determine a difference between the parameter corresponding to a predetermined number of search result entries to display and a number of keyword search results generated using the keyword search. The one or more processors can be configured to select, from the one or more semantic search results, a number of semantic search results to compensate for the difference. The one or more processors can be configured to generate the combination to include the number of keyword search results and the number of semantic search results into the predetermined number of search result to satisfy to the threshold.

The one or more processors can be configured to receive, via the user interface, a new term to combine with the one or more terms of the search query into an updated one or more terms. The one or more processors can be configured to generate, for display in the user interface using the keyword search, an updated one or more keyword search results generated based on the updated one or more terms. The one or more processors can be configured to determine that an updated parameter of the updated one or more keyword search results satisfies the threshold for results to display in the user interface. The one or more processors can be configured to determine, in response to the updated parameter satisfying the threshold, to provide for display via the user interface of the device, the updated one or more keyword search results instead of the combination.

The one or more processors can be configured to determine to use the semantic search responsive to an updated parameter of the updated one or more keyword search results not satisfying the threshold for results to display in the user interface. The one or more processors can be configured to generate, responsive to the updated parameter of the one or more keyword search results not satisfying the threshold and using the semantic search for an updated vector representation of the updated one or more terms and the vector representations of contents to assist with the search query, one or more updated semantic search results. The one or more processors can be configured to provide, for display via the user interface of the device, an updated combination of at least one of the updated one or more of the keyword search results and at least one of the updated one or more of the semantic search results. The updated parameter of the updated combination can satisfy the threshold.

The one or more processors can be configured to determine a weighting parameter according to a length of the search query. The one or more processors can be configured to select from the one or more keyword search results and based on the weighting parameter, a number of keyword search results to include into the combination. The one or more processors can be configured to select from the one or more semantic search results based on the number of keyword search results and the parameter, a number of the one or more semantic search results to include into the combination.

The one or more processors can be configured to receive a new term of the one or more terms of the search query. The one or more processors can be configured to determine an updated weighting parameter according to an updated length of the search query comprising the new term. The one or more processors can be configured to select from the one or more keyword search results and based on the updated weighting parameter, an updated number of keyword search results to include into the combination. The one or more processors can be configured to select from the one or more semantic search results based on the updated number of keyword search results and the parameter, an updated number of the one or more semantic search results to include into the combination.

The one or more processors can be configured to adjust a weighting parameter for at least one of the keyword search results or the semantic search results based on a length of the search query. The one or more processors can be configured to adjust, using the weighting parameter, priority of the one or more semantic search results. The one or more processors can be configured to generate, responsive to the determination and based on the one or more terms, the vector representation of the one or more terms. The one or more processors can be configured to generate the one or more semantic search results based on a similarity search between the vector representation of the one or more terms and vector representations of contents to assist with the search query.

The contents to assist include materials associated with at least one of an application or a document to provide via links in search result entries to display in response to the search query. The one or more processors can be configured to identify a search history of an electronic account associated with the device. The one or more processors can be configured to rank, based on the search history, the one or more keyword search results and the one or more semantic search results. The one or more processors can be configured to provide, for display, the combination according to the ranking.

An aspect of the technical solutions is directed to a method. The method can include one or more processors coupled with memory identifying one or more terms of a search query input into a user interface of a device. The method can include the one or more processors generating for display in the user interface using a keyword search, one or more keyword search results based on the one or more terms. The method can include the one or more processors determining to use a semantic search responsive to a parameter of the one or more keyword search results not satisfying a threshold for results to display in the user interface. The semantic search can be different from the keyword search. The method can include the one or more processors generating, responsive to the determination and using the semantic search for a vector representation of the one or more terms and vector representations of contents to assist with the search query, one or more semantic search results. The method can include the one or more processors providing, for display via the user interface of the device, a combination of at least one of the one or more of the keyword search results and at least one of the one or more of the semantic search results. The parameter of the combination can satisfy the threshold.

The method can include the one or more processors receiving, via a first portion of the user interface for receiving the search query, a first term of the one or more terms of the search query prior to receiving a second term of the one or more terms. The method can include generating, by the one or more processors, for display in a second portion of the user interface for presenting contents to assist, prior to receiving the second term via the user interface, the one or more keyword search results based on the first term of the one or more terms. The method can include providing, by the one or more processors, for display via the second portion of the user interface, prior to receiving the second term via the user interface and based on the first term, the combination of the at least one of the one or more of the keyword search results and the at least one of the one or more of the semantic search results.

An aspect of the technical solutions is directed to a non-transitory computer-readable medium comprising instructions. The instructions, when executed by one or more processors coupled with memory, can cause the one or more processors to identify one or more terms of a search query input into a user interface of a device. The instructions, when executed by one or more processors coupled with memory, can cause the one or more processors to generate, for display in the user interface using a keyword search, one or more keyword search results based on the one or more terms. The instructions, when executed by one or more processors coupled with memory, can cause the one or more processors to determine to use a semantic search responsive to a parameter of the one or more keyword search results not satisfying a threshold for results to display in the user interface. The semantic search can be different from the keyword search. The instructions, when executed by one or more processors coupled with memory, can cause the one or more processors to generate, responsive to the determination and using the semantic search for a vector representation of the one or more terms and vector representations of contents to assist with the search query, one or more semantic search results. The instructions, when executed by one or more processors coupled with memory, can cause the one or more processors to provide, for display via the user interface of the device, a combination of at least one of the one or more of the keyword search results and at least one of the one or more of the semantic search results. The parameter of the combination can satisfy the threshold.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 illustrates an example of a system with providing a user interface with enhanced assistance content searching combining keyword and semantic search results using machine learning.

FIG. 2 illustrates a block diagram of a computing system for implementing the embodiments of the technical solutions, in accordance with embodiments.

FIG. 3 illustrates an example configuration of a system for providing enhanced assistance content searching via a combination of keyword and semantic search results.

FIG. 4 can illustrate an example configuration of a system for providing a combination of keyword and semantic search results.

FIGS. 5-6 illustrate examples of user interfaces configured for receiving search queries and providing assistance contents via a combination of keyword and semantic search results.

FIG. 7 illustrates a flow diagram of a method for providing a user interface with enhanced assistance content searching that combines keyword and semantic search results using machine learning.

### DETAILED DESCRIPTION

The technical solutions described herein are facilitate user interface solutions to provide assistance or help content using a combination of keyword and semantic searches as a search query is being input into the user interface. In a system of applications for processing different enterprise operations (e.g., computer implemented enterprise payroll and human resource operations), the system can provide a user interface for receiving a user entered search query requesting assistance or guidance on completing certain operations. As the user interface continues to receive terms of the search query being entered by the user, the system can perform keyword searches using the already entered terms of the search query. Keyword search results from such a keyword search can provide assistance content to display in an assistance content window (e.g., the help window) of the user interface.

The assistance content window can include the links to various assistance content, such as the applications or materials providing helpful instructions to the user, responsive to search query being entered. The assistance content window, however, can have a preset number of entries for the search results to display to the user. As the number of terms of the search query increases, the keyword search function can produce fewer search results (e.g., due to the search query becoming very long and specific) than the threshold number of entries in the help window. At some point, the number of search results provided by the keyword search function can fall below the predetermined number of search results the user interface is configured to provide. This can result in the assistance content window including an insufficient number of links to the applications or contents for assistance, rendering this feature unsuitable for its intended purpose of providing at least a set number of helpful links and contents, responsive to the search query.

To overcome this technical challenge, the technical solutions described herein utilize machine learning (ML) based semantic search function to supplement the keyword search results with semantic search results when the number of keyword search results falls below a set threshold number of the results to be included in the help content window. In doing so, the technical solutions described herein continue to provide a predetermined number of assistance links regardless of the number of available keyword search results for a given input search query. For instance, when the number of keyword search results for a given search query falls below the threshold number of assistance content links to provide (e.g., due to the length or specificity of the search query), the technical solutions described herein utilize a semantic search function to perform the semantic search between the vector representation of the search query and the vector representations of the assistance contents from the database. The resulting semantic search results can then be used to supplement the keyword search result, thereby maintaining at least a minimum number of the search result links in the help content window, without sacrificing the quality or relevance of the search results provided.

The technical solutions described herein further utilize weighing parameters to weigh the importance of the keyword and semantic search results, determining their ranking and order when presenting them to the user. The weighing parameters can be based on the length of the keyword search. For instance, the semantic parameters can be weighed more as the length of the keyword search being received increases, thereby decreasing the weights for the keyword search as the length of the keyword search increases. The technical solutions can utilize user’s search history to identify the most likely keyword searches to use and apply to the weights and ranking of the search results. For example, the technical solutions can use JSON data structures in which relevant assistance content can be summarized via machine learning. These JSON data structure summaries of assistance contents (e.g., helpful documents, guidelines, or instructions) can be used to generate the relevant vector representations of the assistance contents to be used for semantic searching (e.g., via similarity functions) and comparisons with the vector representation of the search query. Using the vector representations of the search query and the vector representations of the assistance contents, the technical solutions can identify (e.g., via similarity function) the most contextually similar semantic search results to include into a combination of keyword and semantic search result links in the help content window, thereby maintaining the predetermined number of helpful content links regardless of the search query’s length or specificity.

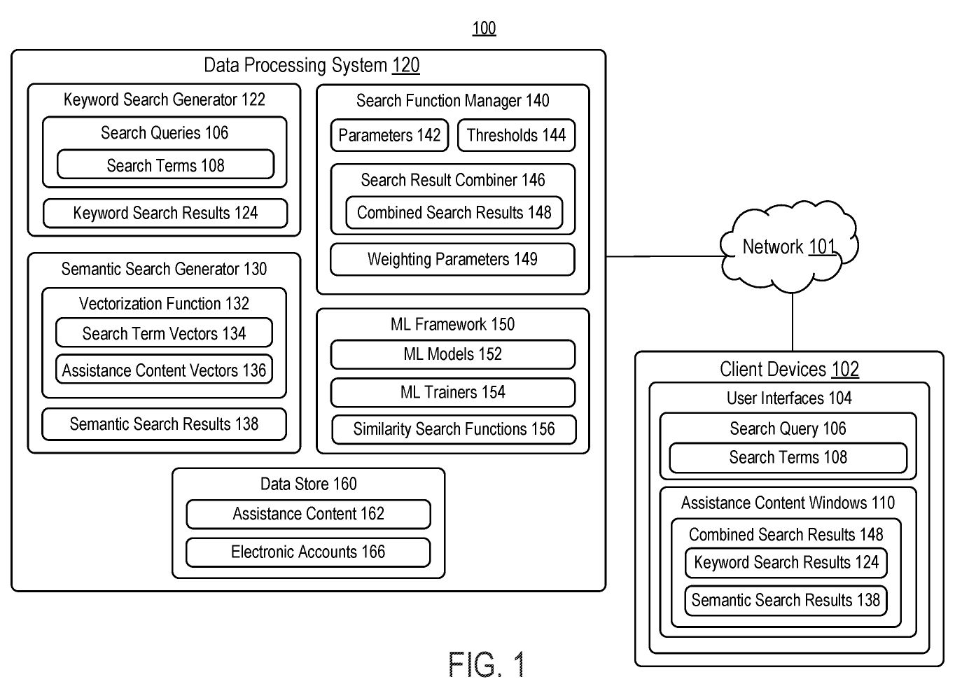

FIG. 1 illustrates an example system 100 providing a user interface with enhanced assistance content searching that combines keyword and semantic search results using machine learning. Example system 100 can include one or more data processing systems 120 communicatively coupled with one or more client devices 102, via one or more networks 101. A client device 102 can include one or more user interfaces 104 for receiving user-entered search queries 106 and providing one or more assistance content windows 110 for displaying the content that is helpful to the user and responsive to the search queries 106. The search queries 106 can include any number of search terms 108 inquiring about various topics, such as specific network or application operations, compliance documents or requests for help with particular features of the system. The assistance content windows 110 can provide for display combined search results 148 that can include any combination of keyword search results 124 and semantic search results 138 with information or access (e.g., links) to various assistance content 162 responsive to the search query 106.

Across the network 101, a data processing system 120 can receive from the client device 102 the search terms 108 of the search queries 106 and provide in return the combined search results 148 comprising one or more keyword search results 124 and semantic search results 138. The data processing system 120 can include, execute or operate one or more of keyword search generators 122, semantic search generators 130, search function managers 140, ML frameworks 150 and data stores 160. A keyword search generator 122 can receive and process the search terms 108 of the search queries 106 from the client devices 102 and generate keyword search results 124 by performing a keyword search of the assistance content 162 using the search terms 108. A semantic search generator 130 that can include and utilize one or more vectorization functions 132 for generating search term vectors 134 (e.g., vectors of the search terms 108) as well as generating assistance content vectors 136 (e.g., vectors of the assistance content 162) to represent the assistance content or help data. The semantic search generator can utilize the search term vectors 134 and the assistance content vectors 136 to generate (e.g., via a similarity search analysis) the semantic search results 138 to include in the combined search results 148.

A search function manager 140 of the data processing system 120 can include or track various parameters 142 (e.g., a number of keyword search results generated or a quality level of the search results generated) and thresholds 144 (e.g., minimal number of combined search results to include into the combined search results 148). The search function manager 140 can include and execute a search result combiner 146 that can utilize the parameters 142, thresholds 144, and any weighting parameters 149 (e.g., weights for various results) to generate the combined search results 148. The ML framework 150 can include one or more ML models 152 configured or trained by ML trainers 154 to generate search term vectors 134 for the input search terms 108 as well as assistance content vectors 136 for the assistance content 162 on behalf of the semantic search generator 130. The ML models 152 can be configured to generate or select, on behalf of the search function manager 140, any particular keyword search results 124 and semantic search results 138 to include into the combined search results 148 based on the specific parameters 142, thresholds 144 and weighting factors 149, or based on the user data of the electronic accounts 166. The data store 160 can store and provide access to assistance content 162 (e.g., help contents or machine learning generated summaries or data structures of the help contents) as well as electronic accounts 166 (e.g., historical search data of the users associated with the accounts).

Client device 102 can include any computing device capable of receiving user input and displaying information. Client device 102 can be a desktop computer, laptop, tablet, or a smartphone. Client device 102 can include one or more user interfaces 104 for receiving user-entered search queries 106 and providing one or more assistance content windows 110 for displaying helpful content responsive to the search queries 106. For example, client device 102 can receive search terms 108 from a user and transmit these terms to data processing system 120 for generating combined search results 148. Client device 102 can display the combined search results 148, which include keyword search results 124 and semantic search results 138, in the assistance content window 110.

User interface 104 can include any graphical interface that allows users to interact with a system. User interface 104 can be a web-based interface, a mobile app interface, a graphical user interface or a desktop application interface. User interface 104 can receive user-entered search queries 106 and display assistance content in the assistance content window 110. User interface 104 can include graphical components or elements, such as selection buttons, search term prompts, output or pop-up windows (e.g., for providing combined search results 148), or links or access to various applications or assistance contents 162. For example, user interface 104 can display keyword search results 124 and semantic search results 138 in response to search queries 106 being entered by a user. The user interface can provide the assistance content window 110 with the combined search results 148 having one or more keyword search results 124 and one or more semantic search results 138 while the user is still entering the search terms 108. The user interface 104 can provide interactive elements, such as buttons and links, to facilitate user navigation and access to assistance content 162.

Search query 106 can include any input (e.g., a string of characters) entered or provided by a user into the user interface 104. The search query 106 can include a textual request for information or assistance received via a search term prompt portion of the user interface 104. The search query 106 can include one or more words, phrases, or a complex query with multiple terms (e.g., a sentence or a paragraph). Search query 106 can be entered into the user interface 104 and processed by data processing system 120 to generate search results (e.g., the combined search results to display in the assistnace content window 110) in real-time (e.g., as the search terms 108 of the search query 106 are being entered and received). For example, individual search terms 108 of the search query 106 can be transmitted to keyword search generator 122, the semantic search generator 130 and the search function manager 140 as the search terms 108 arrive to the user interface 104. Continuously updating the search terms 108 to the data processing system 120 allow the system to generate or update the keyword search results 124 and the semantic search results 138 in real-time as the search query 106 is still being generated. Search query 106 can be used to identify relevant assistance content 162 to display in the assistance content window 110.

Search term 108 can include any individual portion of a search query 106, such as a word or a phrase that is a subcomponent of the overall search query 106. For instance, a search term 108 can be a keyword, a specific term, or a combination of words. Search term 108 can be used by keyword search generator 122 to perform keyword searches and generate keyword search results 124. For example, search term 108 can be vectorized by vectorization function 132 to generate search term vectors 134. These vectors can be compared with assistance content vectors 136 to generate semantic search results 138. For instance, vectorized search terms 108 can be embeddings of the search terms 108 generated by embedding ML models 152, which the semantic search generator 130 can use for identifying semantic search results 138 by matching the vectorized assistance content 162 (e.g., assistance content vectors 136) with the search term vectors 134 using a similarity search function 156.

Assistance content window 110 can include any functionality or display area within the user interface 104 that presents combined search results 148 of the assistance content 162. For instance, assistance content window 110 can be a dedicated help window, a sidebar, or a pop-up window that can be displayed or provided in response to combined search results 148 generated responsive to search terms 108 of a search query 106. Assistance content window 110 can be continuously updated with additional or newly received search terms 108 and modify the combined search results 148 with different keyword search results 124 and semantic search results 138. Assistance content window 110 can provide links to various assistance content 162, such as applications or materials providing helpful instructions to the user. Assistance content window 110 can maintain a predetermined (e.g., a threshold 144) number of search result links having any number of keyword or semantic search results, regardless of the length or specificity of the search query 106.

Network 101 can include any communication network that facilitates the transmission of data between client devices 102 and data processing system 120. Network 101 can be a local area network (LAN), a wide area network (WAN), the internet, or a combination of these networks. For example, network 101 can be a corporate intranet that connects various client devices within an organization to the central data processing system 120. Network 101 can also be a cloud-based network that allows remote client devices to access the data processing system 120 over the internet. Additionally, network 101 can include wireless communication networks, such as Wi-Fi or cellular networks, enabling mobile devices to connect to the data processing system 120. The network 101 can direct communication lines (e.g., wire connections) or wireless connections between various components of the system 100.

Data processing system 120 can include any combination of hardware and software for processing search queries and generating search results. Data processing system 120 can include, or be executed on, a server, a cloud-based system, or a distributed computing system of an enterprise, such as a corporation or an organization providing employee or employer services, including payroll, tax or regulatory compliance computing operations. Data processing system 120 can receive search terms 108 of a search query 106 from client device 102 and generate combined search results 148. For example, data processing system 120 can operate or execute any one or more of a keyword search generator 122, a semantic search generator 130, a search function manager 140, an ML framework 150, or a data store 160. Data processing system 120 can process search queries 106 and provide relevant assistance content 162 to display in the assistance content window 110. For example, data processing system 120 can execute keyword search generator 122 to perform a keyword search of assistance content 162 in a data store 160 and identify keyword search results 124. Data processing system 120 can utilize a vectorization function 132 of a semantic search generator 130 to vectorize (e.g., create embeddings of) the assistance content 162 as well as the search term 108 (e.g., to create search term vector 134) and generate semantic search results 138 (e.g., using a semantic search generator 130).

Keyword search generator 122 can include any software or algorithm for performing keyword searches based on search terms 108 received from the client device 102. Keyword search generator 122 can include or operate a search engine, a database query system, or a text-matching algorithm. Keyword search generator 122 can receive search terms 108 from search queries 106 and generate keyword search results 124. For example, keyword search generator 122 can perform a keyword search of assistance content 162 using the search terms 108 as they arrive from the client device 102. For instance, while search terms 108 are being received at the user interface 104, the keyword search generator 122 can continuously re-execute or rerun the keyword search using the most updated set of search terms 108 of the continuously updated search query 106. Keyword search results 124 can be combined with semantic search results 138 to provide a comprehensive set of search results in the assistance content window 110.

Keyword search results 124 can include any search results generated by keyword search generator 122 based on search terms 108. Keyword search results 124 can be a list of, or links to, any relevant documents (e.g., guidelines, instructions, regulations, laws, tax documents or employment data), links to applications, or other assistance content 162. Keyword search results 124 can be displayed in the assistance content window 110. For example, keyword search results 124 can be generated by performing a keyword search of assistance content 162 using the search terms 108. If the keyword search results 124 do not satisfy a threshold parameter, semantic search results 138 can be used to supplement the keyword search results 124.

Semantic search generator 130 can include any software or algorithm for performing semantic searches based on vector representations of search terms 108 and assistance content 162. Semantic search generator 130 can include, trigger or utilize a machine learning model (e.g., ML model 152), such as a natural language processing algorithm, or a similarity search function 156. Semantic search generator 130 can generate semantic search results 138 by comparing search term vectors 134 with assistance content vectors 136 (e.g., using a similarity search function 156). Semantic search generator 130 can utilize ML models 152 trained by ML trainers 154 to generate embeddings or vector representations of assistance content 162 (e.g., help documents or data) to generate assistance content vectors 136. Semantic search generator 130 can utilize ML models 152 to generate data structures (e.g., JSON data structure) of summaries of assistance content 162, which can then be used to generate assistance content vectors 136 (e.g., based on the data structures of summaries of the assistance content documentation). For example, semantic search generator 130 can utilize vectorization function 132 to generate search term vectors 134 from incoming (e.g., still being received) search terms 108 of the search query 106. Semantic search generator 130 can include the functionality to trigger or utilize similarity search functions 156 (e.g., cosine similarity) to identify assistance content 162 whose assistance content vectors 136 most closely relate to (e.g., are most closely matching) the search term vectors 134 of the search query 106. Semantic search results 138 can be combined with keyword search results 124 to provide a comprehensive set of search results in the assistance content window 110.

Vectorization function 132 can include any software or algorithm for generating vector representations of search terms 108 and assistance content 162. Vectorization function 132 can include, trigger, utilize or be a machine learning model, a natural language processing algorithm, or a feature extraction function, which can be configured for generating embedding vectors of textual material (e.g., search terms 108 or assistance content 162). Vectorization function 132 can generate search term vectors 134 and assistance content vectors 136. For example, vectorization function 132 can process search terms 108 to generate search term vectors 134 and process assistance content 162 to generate assistance content vectors 136. These vectors can be used by semantic search generator 130 to generate semantic search results 138.

Search term vectors 134 can include any vector representations of search terms 108 generated by vectorization function 132. Search term vectors 134 can be a numerical representation, a feature vector, or an embedding of a word or a phrase of a search term. Search term vector 134 can be an embedding or a vector of a portion of the search query 106 (e.g., as the search terms 108 are being received by the system) or of an entire search query 106 (e.g., once all the search terms 108 of the search query 106 are received). Search term vectors 134 can be generated by a ML model 152 and can be used by semantic search generator 130 to perform similarity searches. For example, search term vectors 134 can be compared with assistance content vectors 136 to generate semantic search results 138. Search term vectors 134 can represent the semantic meaning of the search terms 108 and be used to identify contextually relevant assistance content 162.

Assistance content vectors 136 can include any vector representations of assistance content 162 generated by vectorization function 132. Assistance content vectors 136 can be a numerical representation, a feature vector, or an embedding of any assistance content (e.g., help content) such as regulatory documents, payroll processing guidelines, tax compliance instructions, employee benefits information, payroll software user manuals, wage and hour laws, direct deposit setup guides, payroll tax filing procedures, employee onboarding checklists, payroll error troubleshooting steps, and payroll audit preparation materials. Assistance content vectors 136 can be used by semantic search generator 130 to perform similarity searches. For example, assistance content vectors 136 can be compared with search term vectors 134 to generate semantic search results 138. Assistance content vectors 136 can represent the semantic meaning of the assistance content 162 and be used to identify contextually relevant search results.

Semantic search results 138 can include any search results generated by semantic search generator 130 based on vector representations of search terms 108 and assistance content 162. Semantic search results 138 can include one or more of, or a list of relevant documents, links to applications, or other assistance content 162. Semantic search results 138 can include the same or similar assistance content 162 as the keyword search results 124, but identified using a similarity search, as opposed to a keyword search. Semantic search results 138 can be displayed in the assistance content window 110. For example, semantic search results 138 can be generated by comparing search term vectors 134 with assistance content vectors 136. Semantic search results 138 can be combined with keyword search results 124 to provide a comprehensive set of search results in the assistance content window 110.

Search function manager 140 can include any combination of hardware and software for managing search functions and generating combined search results 148. Search function manager 140 can be executed on a server, a cloud-based system, or a distributed computing system to select or combine various keyword search results 124 and semantic search results 138 into combined search results 148 to display in the assistance content window 110. Search function manager 140 can track and utilize various parameters 142 (e.g., the total number of generated keyword search results 124 or a total number of generated semantic search results 138) and thresholds 144 (e.g., a predetermined number of combined search results 148 to include into the assistance content window 110) to select, construct, create, produce or generate combined search results 148. For example, search function manager 140 can include a search result combiner 146 that utilizes a parameter 142 pertaining to a number of keyword search results 124 generated by a keyword search generator 122 in view of a threshold 144 number for the number of entries or search results (e.g., semantic or keyword) to include into the assistance content window. Search function manager 140 can utilize weighting parameters 149 to generate combined search results 148, such as by applying the weight on the importance of keyword versus semantic search results. For instance, when a search query 106 grows very long or specific (e.g., number of search terms 108 exceed a predetermined threshold for the search terms), the search function manager 140 can apply a weighting parameter 149 to reduce the number of the keyword search results to use, increasing the number of semantic search results 138 to include into the assistance content window 110. In doing so, the search function manager 140 can utilize parameters 142 or weighting parameters 149 to ensure that the combined search results 148 meet the relevance and quality thresholds.

Parameters 142 can include any metrics or criteria used by search function manager 140 to evaluate search results. Parameters 142 can include a number of keyword search results generated, the quality level of the search results, the relevance (e.g., relevance score) of the search results, the response time for generating search results, the user satisfaction rating, the accuracy of the search results, the diversity of the search results, the freshness of the search results, or other metrics. Parameters 142 can be used to determine whether the keyword search results 124 satisfy a threshold 144. For example, parameters 142 can be compared with thresholds 144 pertaining to a given parameter 142 (e.g., a number of keyword search results generated or the quality or relevance level of the search results) to determine if additional semantic search results 138 are to be generated to supplement the keyword search results 124. Parameters 142 can help ensure that the combined search results 148 meet the desired relevance and quality standards (e.g., a total number of entries in the assistance content window 110 for the search results to be provided).

Thresholds 144 can include any predefined limits or criteria used by search function manager 140 to evaluate search results. Thresholds 144 can be a minimum number of search results to display, a quality threshold for the search results, or other relevant criteria. Thresholds 144 can be used to determine whether the keyword search results 124 satisfy the desired criteria. For example, thresholds 144 can be compared with parameters 142 to determine if additional semantic search results 138 are needed to supplement the keyword search results 124. Thresholds 144 can help ensure that the combined search results 148 meet the desired relevance and quality standards.

Search result combiner 146 can include any software or algorithm for combining keyword search results 124 and semantic search results 138. Search result combiner 146 can be a ranking algorithm, a merging function, or a prioritization mechanism to select, combine or provide a selection and ordering of the keyword search results 124 and semantic search results 138 of the combined search results 148. Search result combiner 146 can utilize parameters 142, thresholds 144, and weighting parameters 149 to generate, select, pick, construct or order the combined search results 148. For example, search result combiner 146 can select a number of keyword search results 124 to combine with a selected number of semantic search results 138 to provide a comprehensive set of search results in the assistance content window 110 and to meet a desire or standard for a predetermined number of search results to display in the assistance content window 110. Search result combiner 146 can ensure that the combined search results 148 meet the relevance and quality thresholds.

Combined search results 148 can include any combination of keyword search results 124 and semantic search results 138. Combined search results 148 can include a list, a selection, or a grouping of links or summaries of any one or more assistance contents 162 identified by any combination of one or more keyword search results 124 or semantic search results 138. Combined search results 148 can include relevant documents, links to applications, or other assistance content 162. Combined search results 148 can include strings of characters (e.g., links or description summaries) to be displayed in the entries of assistance content window 110 in response to the received search terms 108. For example, combined search results 148 can include keyword search results 124 generated by keyword search generator 122 and semantic search results 138 generated by semantic search generator 130. Combined search results 148 can provide a comprehensive set of search results that meet the relevance and quality thresholds.

Weighting parameters 149 can include any metrics or criteria used by search function manager 140 to weigh the importance of keyword search results 124 and semantic search results 138. Weighting parameters 149 can be based on the length of the search query 106, the relevance of the search results, data or preferences inferred from user’s search history (e.g., electronic account 166 associated with the user), the click-through rate of the search results, the freshness of the search results, the diversity of the search results, the quality score of the search results, the response time for generating search results, the user satisfaction rating, or other relevant factors. Weighting parameters 149 can be used to determine the ranking and order of the combined search results 148. For example, weighting parameters 149 can be adjusted based on the length of the search query 106 to prioritize semantic search results 138 when the query is longer and more specific. Weighting parameters 149 can help ensure that the combined search results 148 meet the desired relevance and quality standards.

ML framework 150 can include any combination of hardware and software for implementing machine learning models and algorithms. ML framework 150 can be a machine learning platform, a cloud-based service, or a distributed computing system that can be configured or trained to generate or produce embedding vectors, summaries of assistance contents 162, data structures of such summaries and similarity searching based on generated vector embeddings. ML framework 150 can include one or more ML models 152 configured or trained by ML trainers 154 to generate search term vectors 134 and assistance content vectors 136. For example, ML framework 150 can be used by semantic search generator 130 to perform similarity searches and generate semantic search results 138. ML framework 150 can help ensure that the search results are accurate and contextually relevant.

ML framework 150 can include any combination of hardware and software for providing or implementing any type and form of ML or artificial intelligence (AI) functionalities of the data processing system. The ML framework 150 can manage and provide ML trainers 154 for training ML models 152 to perform functionalities of any of the components of the data processing system 120 (e.g., semantic search generator 130 or search function manager 140). For example, an ML framework 150 can utilize an ML trainer 154 to train an ML model 152 (e.g., via a large corpus of text data to train vector embedding generation) to generate embedding vectors of assistance contents 162 (e.g., assistance content vectors 136) and generate embedding vectors of search terms 108 (e.g., search term vectors 134). For example, the ML framework 150 can utilize an ML trainer 154 to train an ML model 152 to generate textual summaries (e.g., single paragraph summaries of documents) of various assistance content 162. ML framework 150 can provide similarity search function 156 to identify assistance content 162 that is most similar (e.g., most closely related) to the search query 106.

ML models 152 can include any machine learning models trained to generate vector representations of search terms 108 and assistance content 162. ML models 152 can be a neural network, a natural language processing model, or a feature extraction algorithm. ML models 152 can be configured or trained by ML trainers 154 to generate search term vectors 134 and assistance content vectors 136. For example, ML models 152 can be used by vectorization function 132 to generate vector representations of search terms 108 and assistance content 162. ML models 152 can help ensure that the search results are accurate and contextually relevant.

The ML models 152 can include any combination of one or more neural networks, decision-making models, linear regression models, natural language models, random forests, classification models, generative AI models, reinforcement learning models, clustering models, neighbor models, decision trees, probabilistic models, classifier models, or other such models. For example, the models 152 include natural language processing (e.g., support vector machine (SVM), Bag of Words, Counter Vector, Word2Vec, k-nearest neighbors (KNN) classification, long short erm memory (LSTM)), object detection and image identification models (e.g., mask region-based convolutional neural network (R-CNN), CNN, single shot detector (SSD), deep learning CNN with Modified National Institute of Standards and Technology (MNIST), RNN based long short term memory (LSTM), Hidden Markov Models, You Only Look Once (YOLO), LayoutLM) (classification ad clustering models (e.g., random forest, XGBBoost, k-means clustering, DBScan, isolation forests, segmented regression, sum of subsets 0/1 Knapsack, Backtracking, Time series, transferable contextual bandit) or other models such as named entity recognition, term frequency-inverse document frequency (TF-IDF), stochastic gradient descent, Naïve Bayes Classifier, cosine similarity, multi-layer perceptron, sentence transformer, data parser, conditional random field model, Bidirectional Encoder Representations from Transformers (BERT), among others.

The ML models 152 can include generative AI models, also referred to as generative AI models 152, which can include any machine learning systems configured to create new content, such as text, images, or audio, by learning patterns from the data stored in a storage or a database (e.g., training datasets). The generative AI models 152 can be trained using techniques, such as supervised learning, unsupervised learning, and reinforcement learning. Generative AI models 152 can utilize data set from the stored data to create logical inferences between various complex structures in the data set to generate coherent outputs for prompts input into the models 152.

The ML models 152 implemented as generative AI models can include any machine learning (ML) or artificial intelligence (AI) model designed to generate content or new content, such as text, images, or code, by learning patterns and structures from existing data. Such ML model 152 (e.g., a generative AI models) can include any model, a computational system or an algorithm that can learn patterns from data (e.g., chunks of data from various input images, videos, documents, computer code, templates, forms, etc.) and make predictions or perform tasks without being explicitly programmed to perform such tasks. The generative AI model 152 can include, utilize or refer to a large language model. The generative AI model 152 can be trained using a dataset of documents (e.g., text, images, videos, audio or other data). The generative AI model 152 can be designed to understand and extract relevant information from the dataset. The generative AI model 152 can leverage natural language processing techniques and pattern recognition to comprehend the context and intent of a prompt (e.g., one or more instructions), which can be used as input into the ML model 152 to trigger the desired output or result.

The ML model 152, including for example a generative AI model, can be designed, constructed, utilize or include a transformer architecture with one or more of a self-attention mechanism (e.g., allowing the model to weigh the importance of different words or tokens in a sentence when encoding a word at a particular position), positional encoding, encoder and decoder (multiple layers containing multi-head self-attention mechanisms and feedforward neural networks). For example, each layer in the encoder and decoder can include a fully connected feed-forward network, applied independently to each position. The data processing system 120 can apply layer normalization to the output of the attention and feed-forward sub-layers to stabilize and improve the speed with which the generative AI model 152 is trained. The data processing system 120 can leverage any residual connections to facilitate preserving gradients during backpropagation, thereby aiding in the training of the deep networks. Transformer architecture can include, for example, a generative pre-trained transformer, a bidirectional encoder representations from transformers, transformer-XL (e.g., using recurrence to capture longer-term dependencies beyond a fixed-length context window), text-to-text transfer transformer,

ML trainers 154 can include any software or algorithms used to train machine learning models. ML trainers 154 can be a training algorithm, a data preprocessing function, or a model optimization technique. ML trainers 154 can be used to configure or train ML models 152 to generate search term vectors 134 and assistance content vectors 136. For example, ML trainers 154 can use training data to optimize the performance of ML models 152. ML trainers 154 can help ensure that the machine learning models generate accurate and contextually relevant vector representations.

ML trainers 154 can include any combination of hardware and software for training ML models 152. ML trainers 154 can use datasets including documents, texts, multimedia or character strings to generate embedding vectors, summaries of assistance content documents, generate JSON data structures comprising such summaries and comparing different keyword and semantic search results to identify and filter out any duplicate results. Through training, a generative ML model 152, also referred to as a generative AI model 152, can learn or adjust its understanding of mapping embeddings to particular issues to implement any features of the semantic search generator 130 or search function manager 140. The internal parameters can include numerical values of a generative AI model that the model learns and adjusts during training to optimize its performance and make more accurate predictions. Such training and can include iteratively presenting the various data chunks or documents of the dataset (e.g., or their chunks, embeddings) to the generative AI model 152, comparing its predictions with the known correct answers, and updating the model's parameters to minimize the prediction errors. By learning from the embeddings of the dataset data chunks, the generative AI model 152 can gain the ability to generalize its knowledge and make accurate predictions or provide relevant insights when presented with prompts.

Similarity search functions 156 can include any software or algorithms used to perform similarity searches based on vector or embedding representations. Similarity search functions 156 can be a cosine similarity function, a Euclidean distance function, or a feature matching algorithm that can be applied to identify assistance content 162 that most closely matches search term vectors 134. Similarity search functions 156 can be used by semantic search generator 130 to compare search term vectors 134 with assistance content vectors 136 and rank or organize the assistance content 162 based on the similarity score (e.g., cosine similarity or Euclidean distance) from the search term vectors 134. For example, similarity search functions 156 can identify the most contextually similar assistance content 162 based on the vector embedding representations. Similarity search functions 156 can help identify the most closely matching assistance content 162 to include in the semantic search results 138 and help maintain the combined search results 148 accurate and contextually relevant.

Data store 160 can include any storage system for storing and providing access to assistance content 162 and electronic accounts 166. Data store 160 can include a database, a cloud storage system, or a distributed storage system. Data store 160 can store assistance content 162, such as help contents or machine learning generated summaries, and electronic accounts 166, such as historical search data of users. For example, data store 160 can provide access to assistance content 162 for keyword search generator 122 and semantic search generator 130.

Assistance content 162 can include any content or materials that provide help or guidance to users. Assistance content 162 can be documents, web pages, application links, or other instructional materials. Assistance content 162 can include, for example, regulatory documents, payroll processing documents or guidelines, tax compliance instructions, tax or employment forms, employee benefits information, payroll software user manuals, wage and hour laws, regulations or guidelines, direct deposit setup guides, payroll tax filing procedures, employee onboarding checklists, payroll error troubleshooting steps, payroll audit preparation materials, human resources employee rulebook or guide or timekeeping system instructions. Assistance content 162 can be stored in data store 160 and accessed by keyword search generator 122 and semantic search generator 130. For example, assistance content 162 can be summarized using machine learning models and represented as assistance content vectors 136. Assistance content 162 can be used to generate keyword search results 124 and semantic search results 138 to display in the assistance content window 110.

Electronic accounts 166 can include any accounts of users utilizing client devices 102 or entering search terms 108 into the user interfaces 104. Electronic accounts 166 can include user accounts that store historical search data and user preferences. Electronic accounts 166 can be a user profile, a search history log, or a personalized settings file. Electronic accounts 166 can be stored in data store 160 and accessed by search function manager 140. For example, electronic accounts 166 can be used to rank and prioritize search results based on user behavior and preferences. Electronic accounts 166 can help ensure that the combined search results 148 are personalized and contextually relevant to the user.

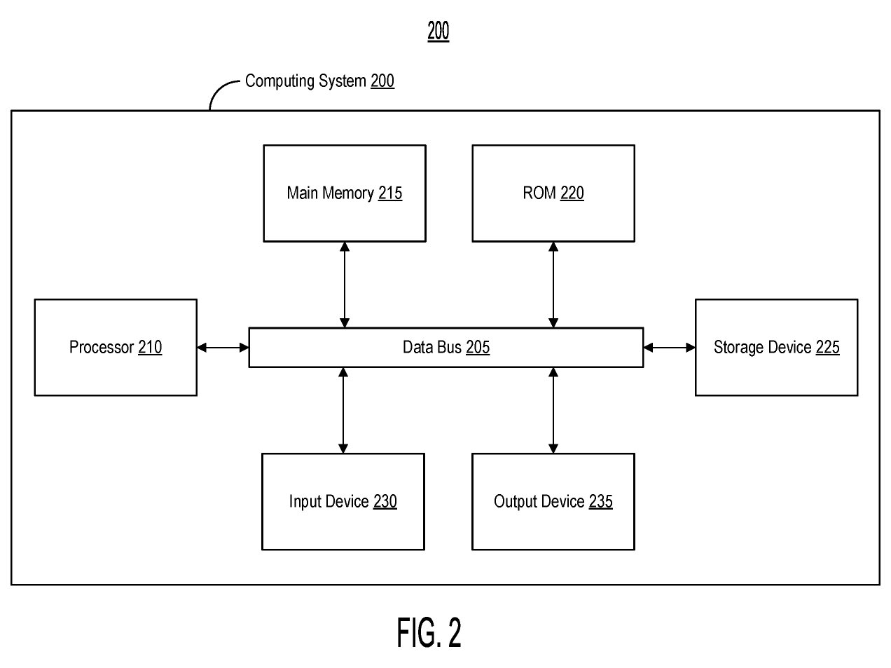

FIG. 2 illustrates a block diagram of a computing system for implementing the embodiments of the technical solutions, in accordance with embodiments. FIG. 2 illustrates a block diagram of an example computing system 200, which can also be referred to as the computer system 200. Computing system 200 can be used to implement elements of the systems and methods described and illustrated herein, such as for example, commands, instructions or data described herein. Computing system 200 can be included in and run any system or device, such as a system 100 of FIG. 1. The computing system 200 can be utilized to provide a data processing system 120 operating on a device, such as a server, as well as a client device 102 that a user can utilize to enter search queries 106 and receiving, viewing or accessing combined search results.

Computing system 200 can include at least one bus data bus 205 or other communication device, structure or component for communicating information or data. Computing system 200 can include at least one processor 210 or processing circuit coupled to the data bus 205 for executing instructions or processing data or information. Computing system 200 can include one or more processors 210 or processing circuits coupled to the data bus 205 for exchanging or processing data or information along with other computing systems 200. Computing system 200 can include one or more main memories 215, such as a random access memory (RAM), dynamic RAM (DRAM), cache memory or other dynamic storage device, which can be coupled to the data bus 205 for storing information, data and instructions to be executed by the processor(s) 210. Main memory 215 can be used for storing information (e.g., data, computer code, commands or instructions) during execution of instructions by the processor(s) 210.

Computing system 200 can include one or more read only memories (ROMs) 220 or other static storage device 225 coupled to the bus 205 for storing static information and instructions for the processor(s) 210. Storage devices 225 can include any storage device, such as a solid state device, magnetic disk or optical disk, which can be coupled to the data bus 205 to persistently store information and instructions.

Computing system 200 may be coupled via the data bus 205 to one or more output devices 235, such as speakers or displays (e.g., liquid crystal display or active matrix display) for displaying or providing information to a user. Input devices 230, such as keyboards, touch screens or voice interfaces, can be coupled to the data bus 205 for communicating information and commands to the processor(s) 210. Input device 230 can include, for example, a touch screen display (e.g., output device 235). Input device 230 can include a cursor control, such as a mouse, a trackball, or cursor direction keys, for communicating direction information and command selections to the processor(s) 210 for controlling cursor movement on a display.

The processes, systems and methods described herein can be implemented by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors 210 in a multi-processing arrangement may also be employed to execute the instructions contained in main memory 215. Hard-wired circuitry can be used in place of or in combination with software instructions together with the systems and methods described herein. Systems and methods described herein are not limited to any specific combination of hardware circuitry and software.

Although an example computing system has been described in FIG. 2, the subject matter including the operations described in this specification can be implemented in other types of digital electronic circuitry, or in computer software, firmware, or hardware, including the structures disclosed in this specification and their structural equivalents, or in combinations of one or more of them.

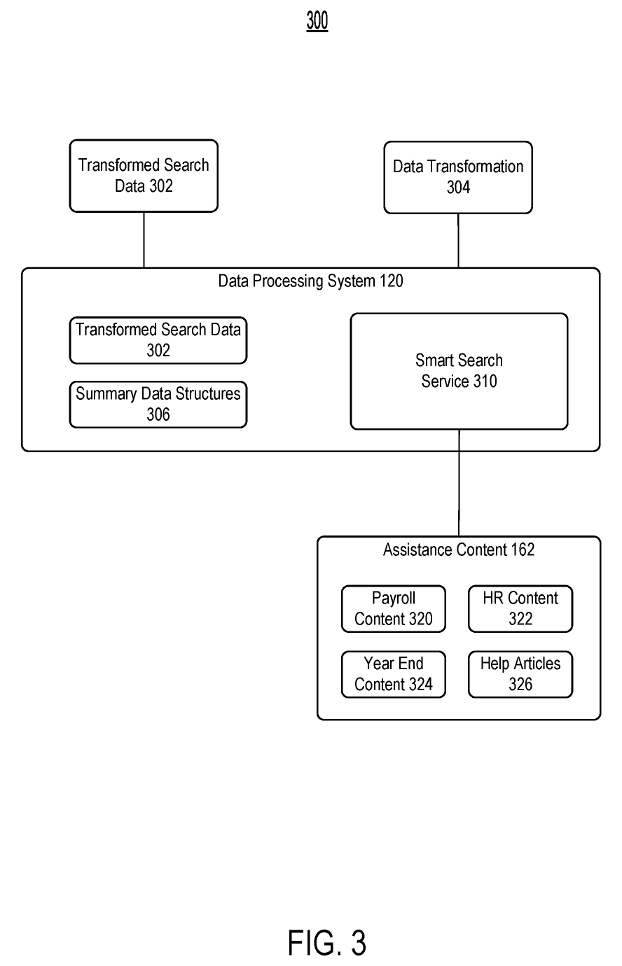

FIG. 3 illustrates an example configuration 300 of a system for providing enhanced assistance content searching via a combination of keyword and semantic search results using machine learning. Example configuration 300 can include one or more transmitted search data 302 and data transformations 304, which can be in communicative communication or shared with a data processing system 120. The data processing system 120 can include the transformed search data 302 and summary data structure 306 (e.g., JSON data structures of summaries of assistance content 162). The data processing system 120 can include one or more smart search services 310 that can include any combination of keyword search generators 122, semantic search generators 130 and search function managers 140 utilizing any features of the ML framework 150.

The transmitted search data 302 can include raw data that is transmitted for search queries, such as user-entered search terms and assistance content 152. Data transformation 304 can include any processing platform that is configured to processes and organizes the transmitted search data to ensure it is ready for further processing. The transformed data can be sent to the data processing system 120 to use the smart search services (e.g., the combination of keyword and semantic searching) to generate combined search results.

Data processing system 120 can include and utilize the transformed search data 302 and summary data structures 306 to operate the smart search service 310. The processed and organized search data can be used along with the summary data structures 306 (e.g., JSON data structures with summarized versions of the assistance content generated using machine learning models) to generate the combination of keyword and semantic search results. The smart search services 310 can utilize machine learning models to generate vector representations of search terms and assistance content, perform similarity searches, and generate formatted HTML search results.

The smart search services 310 can utilize any assistance content 162, including for example, payroll content 320, human resource (HR) content 322, year-end content 324 or help articles 326. The assistance content 162 can include materials that provide help or guidance to users, such as regulatory documents, payroll processing guidelines, tax compliance instructions, and employee benefits information. For instance, the payroll content 320 can include documents related to payroll processing. For example, the HR content 322 can include human resources-related assistance content. For example, the year-end content 324 can include year-end documents and information, while the help articles 326 can include general help articles providing guidance and instructions. The Smart Search Service 310 processes these categories of assistance content to provide accurate and contextually relevant search results to the user.

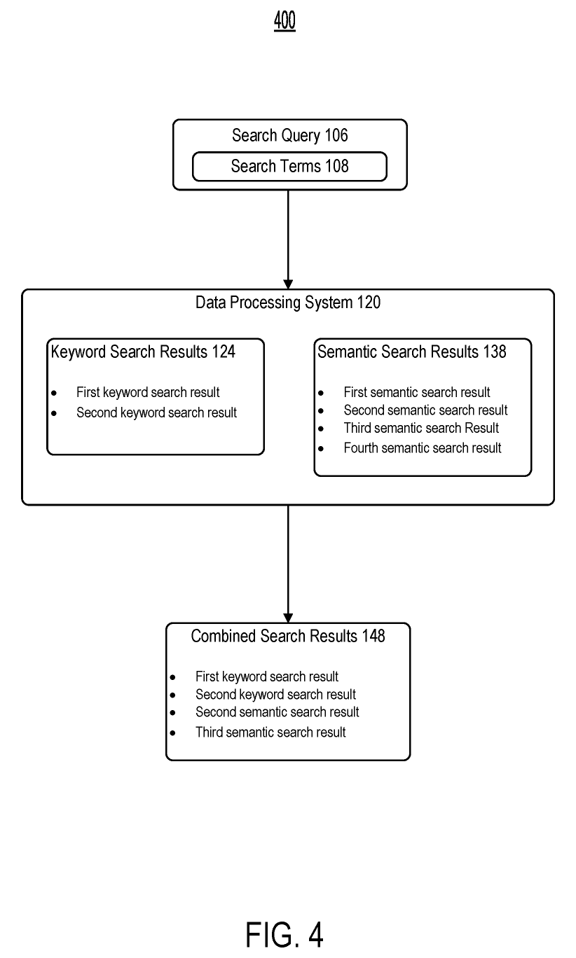

FIG. 4 includes an example configuration 400 of a system for providing a combination of keyword and semantic search results. The example configuration 400 can have the data processing system 120 receiving search queries 106 having specific search terms 108, such as a query “need to run a payroll.” The data processing system 120 can utilize the keyword search generator to generate keyword search results 124, such as a first keyword search result (e.g., “run payroll”) and a second keyword search result (e.g., “payroll home”). The data processing system 120 can utilize a semantic search generator to generate semantic search results 138, such as a first semantic search result (e.g., “run payroll”), a second semantic search result (e.g., “off-cycle payroll”), a third semantic search result (e.g., “payroll info”) and a fourth semantic search result (e.g., “reverse payroll”).

The data processing system 120 can generate the combined search results 148 from a combination of non-duplicate (e.g., deduplicated selection of) the generated keyword and semantic search results. For example, the combined search results 148 can include a first keyword search result (e.g., “run payroll”) and a second keyword search result (e.g., “payroll home”), along with the second semantic search result (e.g., “off-cycle payroll”) and the third semantic search result (e.g., "payroll info”). The data processing system 120 can omit or determine not to include the first semantic search result because it is a duplicate of the first keyword search result (e.g., same as or similar beyond a predetermined similarity threshold to the keyword search result already included in the combination of the search results).

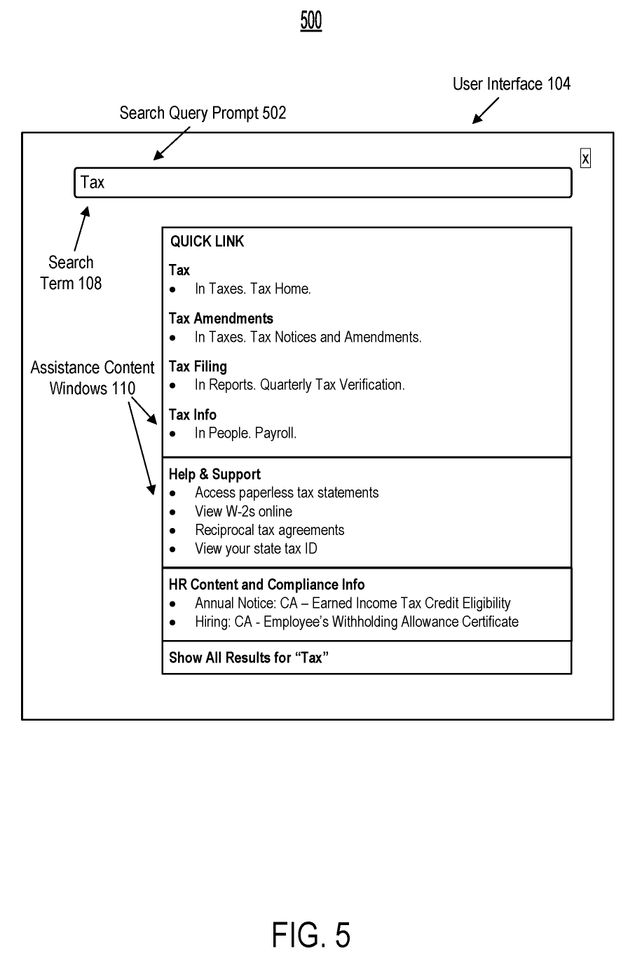

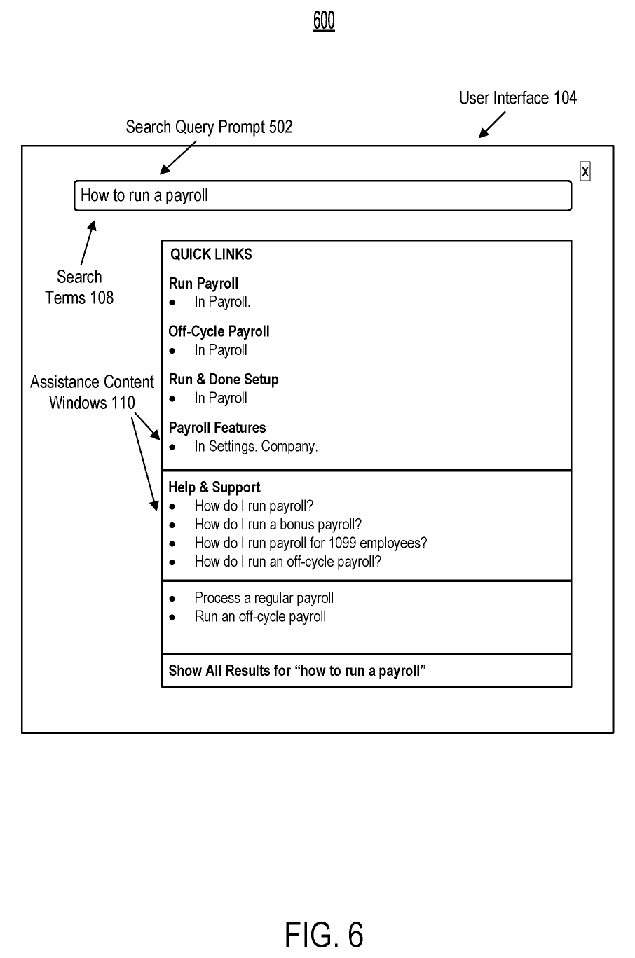

FIGS. 5-6 illustrate examples of user interfaces 104 configured for receiving search queries and providing assistance contents via a combination of keyword and semantic search results. FIG. 5 illustrates an example 500 of a user interface 104 receiving a search term 108 “tax”, based on the which the system provides assistance content windows 110 with various combined search results providing quick links, help and support and options to open all search results to the user, based on that search term 108. FIG. 5 illustrates an example 600 of a user interface 104 receiving a search query 106 with search term 108 “how to run a payroll”, based on the which the system provides assistance content windows 110 with various combined search results providing quick links, help and support and options to open all search results to the user, based on that search query 106.

The user interface 104 of the examples 500 and 600 can each include a search query prompt 502, which can include a portion of the user interface 104 configured (e.g., having a feature or a tool) for receiving one or more search terms 108 (e.g., “tax”, or “how to run a payroll”) entered by a user of the client device 102 executing the user interface 104. The search query prompt 502 can include a window into which the user can enter the characters of this search query 106 to generate the combined search results 148. The user interface 104 can also display, responsive to the search terms 108, one or more assistance content windows 110 for providing various links comprising combined search results (e.g., combination of keyword and semantic search results) providing various links with help contents to the user.

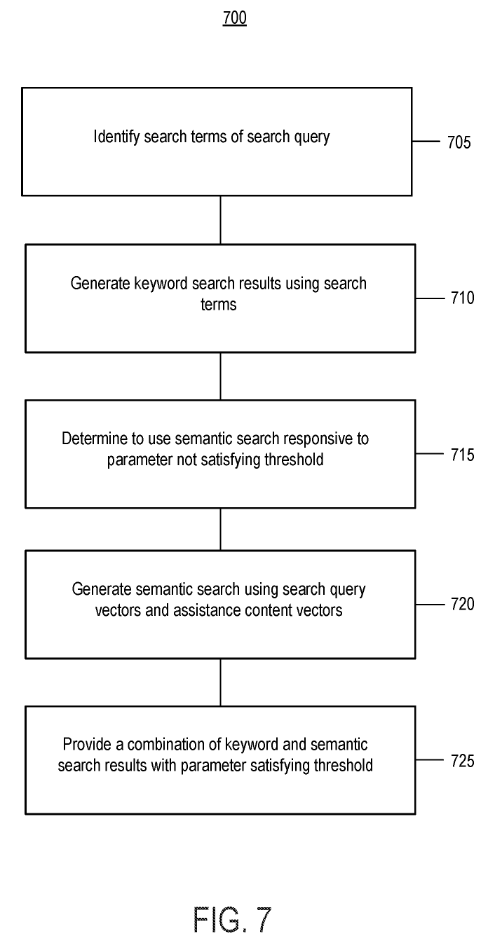

FIG. 7 shows a flow diagram of a method 700 for providing a user interface with enhanced assistance content searching that combines keyword and semantic search results using machine learning. Method 700 can be implemented using the system tools, devices, features, actions and components discussed in FIGS. 1-7. For instance, the method 700 can be implemented using one or more computing environments 200 providing processors 210 that can be configured using instructions, computer code and data stored in memories 215, 220 or 225 to configure or cause the processors 210 to perform any one or more acts or operations of the method 700.

Method 700 can include acts or operations 705-725. At act 705, the method can include identifying search terms of a search query. At act 710, the method can include generating keyword search results using search terms. At act 715, the method can include determining to use a semantic search responsive to a parameter not satisfying a threshold. At act 720, the method can include generating semantic search using search query vectors and assistance content vectors. At 725, the method can include providing a combination of keyword and semantic search results with the parameter satisfying the threshold.

At act 705, the method can include identifying search terms of a search query. The method can include one or more processors coupled with memory identifying one or more terms of a search query input into a user interface of a device. For example, a user interface of a client device communicatively coupled with a data processing system can receive, via a search window of the user interface one or more search terms, such as words, phrases or strings of characters of a search query. The search query can be entered or be in the process of being entered, such as having some of the search terms entered, while others are not yet received by the user interface. The search query can be any search query inquiring or searching information about a process, operation, application, action or a document of a computing system. The computing system can include a payroll operations processing system provided via a network of an enterprise operating a data processing system in communication with the payroll operations processing system.

The user interface can receive multiple search terms (e.g., strings of characters comprising a portion of the search query) over a period of time (e.g., one or more seconds or minutes). During the entry of the search query into the user interface (e.g., while the search terms of the search query are being received) the data processing system can utilize the keyword search generator, semantic search generator and the search function manager to generate and provide for display on the user interface, a set of combined search results including a combination of keyword and semantic search results.

The method can include the user interface receiving, via a first portion of the user interface configured for receiving the search query (e.g., a prompt for receiving search queries), a first term of the one or more terms of the search query. The first term can include a word, a phrase, or a portion of a sentence. The user interface can receive, following the receipt of the first term, a second term of the one or more terms, which can also include a word, a phrase, or a portion of a sentence and which can be followed by other terms of the search query. The search terms can be received over a period of time, allowing the data processing system to provide updated combined search results in response to each of the terms being received in real time.

At act 710, the method can include generating keyword search results based on the search terms received via the user interface. The method can include the one or more processors generating, for display in the user interface using a keyword search, one or more keyword search results based on the one or more terms. For example, a keyword search generator can generate, using a keyword search, one or more search results based on the one or more search terms input into the keyword search function. The keyword search generator can perform the keyword search on the assistance content stored in a data store and identify and rank one or more most closely matching pieces of content. For example, the keyword generator can utilize search terms to identify the same or similar search terms within the various documents or materials of the assistance content and select those with the largest number of matching terms.

The method can include a user interface receiving a new or an updated term of the one or more search terms of the search query, and the keyword search generator can combine the new term with the previously received one or more terms of the search query to form an updated one or more terms. The method can include generating, by the keyword search generator, for display in the user interface, using the keyword search, an updated one or more keyword search results based on the updated one or more terms. The method can include updating one or more keyword search results of the combined search results displayed in the user interface using the updated one or more keyword search results generated based on the updated one or more terms.

The method can include determining a weighting parameter according to a length of the search query. For example, a search function manager can determine or generate a weight parameter for a search query (e.g., the one or more search terms) based on the length of the search query, the type of content of the search query, a level of relevance of the keyword search results, or the number of the keyword search results generated using the one or more search terms of the search query. The method can include the keyword search generator selecting from the one or more keyword search results and, based on the weighting parameter, a number of keyword search results to include in the combination of search results (e.g., the combined search results to be displayed in the assistance content window of the user interface of the client device).

The method can include the user interface or the data processing system receiving a new term (e.g., the latest in a series of search terms) of the one or more terms of the search query and determining an updated weighting parameter according to an updated length of the search query comprising the new term. The search function manager can adjust keyword search query based on the updated weighting parameter. The search function manager can adjust a weighting parameter for at least one of the keyword search results or the semantic search results based on a length of the search query.

At act 715, the method can include determining to use a semantic search responsive to a parameter not satisfying a threshold. The method can include the one or more processors determining to use a semantic search responsive to a parameter of the one or more keyword search results not satisfying a threshold for results to display in the user interface. The parameter can be a value of a number of keyword search results generated by the data processing system using the search terms. The threshold can include a value of a number of total search results to include in the combined search results combining both the keyword and semantic search results to display in the user interface. The semantic search can be different from the keyword search. For instance, the semantic search can include results of similarity search function comparing search term vectors (e.g., vector embeddings of the one or more search terms) with assistance content vectors (e.g., vector embeddings of assistance content documents or materials or machine learning generated summaries of the assistance contents).

For example, the search function manager can determine that the parameter does not satisfy the threshold, and based on this determination, initiate or trigger the semantic search. The parameter can include a number of the one or more keyword search results generated using the keyword search. The method can include the one or more processors determining that the parameter does not satisfy the threshold for the parameter in response to a comparison of the parameter value and the number of the keyword search results generated by the keyword search generator using the one or more search terms. For example, the parameter can correspond to a level of quality of the one or more keyword search results. The level of quality can be determined (e.g., by the semantic search generator utilizing a similarity search function) based on a similarity search between the one or more terms and the one or more keyword search results. The method can include the one or more processors determining that the parameter does not satisfy the threshold in response to a comparison of the parameter and the level of quality (e.g., the level of quality determined based on the similarity search function output for the keyword or semantic search result exceeding a threshold level of similarity).

The method can include the search function manager determining a difference between the parameter corresponding to a predetermined number of search result entries to display and a number of keyword search results generated using the keyword search. The search function manager can select, from the one or more semantic search results, a number of semantic search results to compensate for the difference. The number of the semantic search results can be determined based on the parameter corresponding to the total number of keyword search results generated, or the total number of keyword search results with a sufficient level of quality (e.g., similarity search of the search result exceeding the threshold for the level of similarity between the search result and the assistance content identified by the search).

The method can include the search function manager determining that an updated parameter of the updated one or more keyword search results satisfies the threshold for results to be displayed in the user interface. The method can include the search function manager determining, in response to the updated parameter satisfying the threshold, to provide for display via the user interface of the device, the updated one or more keyword search results instead of the combination. For instance, if the parameter of the keyword search results satisfies the threshold, the search function manager can determine not to complete the semantic search and instead insert into the combined search results only the keyword search results. For instance, if the parameter of semantic search results satisfies the threshold (e.g., similarity search function provides more than a threshold number of semantic search results whose similarity scores exceed a quality or similarity threshold), the search function manager can determine to insert into the combined search results only the semantic search results.

The method can include the search function manager determining to use the semantic search responsive to an updated parameter of the updated one or more keyword search results not satisfying the threshold for results to display in the user interface. The search function manager can generate one or more updated semantic search results in response to the updated parameter of the one or more keyword search results not satisfying the threshold. The search function manager can generate the one or more updated semantic search results using the semantic search for the updated vector representation of the updated one or more terms and the vector representations of contents to assist (e.g., assistance content).

When an updated weighting parameter is determined according to an updated length of the search query (e.g., based on the new search term), the search function manager can select, from the one or more semantic search results based on the updated number of keyword search results and the parameter, an updated number of the one or more semantic search results to include into the combination. The search function manager can adjust, using the weighting parameter, priority of the one or more semantic search results. The search function manager can identify a search history of an electronic account associated with the device and rank, based on the search history, the one or more keyword search results and the one or more semantic search results.

At act 720, the method can include generating semantic search using search query vectors and assistance content vectors. The method can include the semantic search generator generating one or more semantic search results, responsive to the determination that the parameter does not satisfy the threshold. The semantic search generator can generate the one or more semantic search results using the semantic search for a vector representation of the one or more terms (e.g., search term vectors) and vector representations of contents to assist with the search query (e.g., assistance content vectors).

The semantic search generator can utilize one or more machine learning models trained to generate textual summaries of assistance contents. The textual summaries can be packaged or constructed into data structures, such as JSON data structures or JSON objects. The semantic search generator can identify one or more machine learning models trained to generate vector representations of the summaries of the contents to assist with search queries (e.g., summaries of the assistance contents). The semantic search generator can generate, using the contents to assist input into the one or more machine learning models, data structures of summaries of the contents to assist. The semantic search generator can generate, using the data structures input into the one or more machine learning models, vector representations of the contents to assist (e.g., assistance content vectors). Upon receiving one or more terms of a search query, the semantic search generator can utilize one or more embedding machine learning models to generate search term vectors in order to perform a similarity search (e.g., via a similarity search function) with assistance content vectors of the summarized (e.g., data structures containing summaries of) assistance content materials.

The assistance content, or the contents to assist with the search query, can include materials associated with at least one of an application or a document to provide via links in search result entries to display in response to the search query. The contents to assist (e.g., the assistance content) can include at least one of a web page associated with one or more services to be provided via the user interface or a document associated with the one or more services to be provided via the user interface. The data structures can include one or more JavaScript Object Notation (JSON) data structures.

The method can include the search function manager selecting, from the one or more semantic search results, a number of semantic search results to compensate for the difference between the number of the combined search terms to include into the assistance content window of the user interface and the number of generated keyword search results. The search function manager can generate the combination of the search terms to include the number of keyword search results and the number of semantic search results into the predetermined number of search results to satisfy to the threshold (e.g., for the predetermined number of search term results to include into the combined search results displayed in the assistance content window).

The method can include the search function manager of the data processing system selecting a number of keyword search results to include into the combination. The keyword search results can be selected from the one or more keyword search results and based on the weighting parameter. The method can include the data processing system selecting a number of the one or more semantic search results to include into the combination. The number of the semantic search results can be selected from the one or more semantic search results based on the number of keyword search results and the parameter, or based on the quality level and the parameter. The method can include the semantic search generator generating, responsive to the determination and based on the one or more terms, the vector representation of the one or more terms. The semantic search generator can generate the one or more semantic search results based on a similarity search between the vector representation of the one or more terms and vector representations of contents to assist with the search query.

At 725, the method can include providing a combination of keyword and semantic search results with the parameter satisfying the threshold. The method can include the one or more processors providing, for display via the user interface of the device, a combination of at least one of the one or more of the keyword search results and at least one of the one or more of the semantic search results (e.g., the combined search results). The provided combined search results can have the parameter of the combination satisfying the threshold. For example, the parameter for the total number of search terms can satisfy the threshold number of search terms to include into the assistance content window. For example, the parameter for the quality level of the search terms can satisfy the threshold for the satisfactory relevance or similarity score of a similarity search function. The client device can display the combined search results into the assistance content window providing helpful content to the user in response to the search terms of the search query received.

The method can include the user interface receiving, via a first portion of the user interface for receiving the search query, a first term of the one or more terms of the search query prior to receiving a second term of the one or more terms. The data processing system can generate, for display in a second portion of the user interface for presenting contents to assist (e.g., the assistance content window), prior to receiving the second term via the user interface, the one or more keyword search results based on the first term of the one or more terms. The user interface can display the one or more keyword search results based on the first term. The data processing system can provide, for display via the second portion of the user interface (e.g., the assistance content window), prior to receiving the second term via the user interface and based on the first term, the combination of the at least one of the one or more of the keyword search results and the at least one of the one or more of the semantic search results (e.g., a set of combined search results).

The method can include the user interface or the data processing system receiving, via the first portion of the user interface, the second term of the search query and generating, for display in the second portion of the user interface, the one or more keyword search results based on the first term and the second term. The data processing system can provide, for display via the second portion of the user interface (e.g., the assistance content window) and based on the first term and the second term, the combination of the at least one of the one or more of the keyword search results and the at least one of the one or more of the semantic search results. Such combined search results can include keyword and semantic search results that are updated responsive to the second search term supplementing the first search term (e.g., via an updated one or more search terms).

The method can include data processing system determining, in response to the updated parameter satisfying the threshold, to provide for display via the user interface of the device, the updated one or more keyword search results instead of the combination. The method can include the data processing system generating one or more updated semantic search results, responsive to the updated parameter of the one or more keyword search results not satisfying the threshold and using the semantic search for an updated vector representation of the updated one or more terms and the vector representations of contents to assist with the search query. The data processing system can provide, for display via the user interface of the device, an updated combination of at least one of the updated one or more of the keyword search results and at least one of the updated one or more of the semantic search results, wherein the updated parameter of the updated combination satisfies the threshold. The data processing system can rank, based on the search history, the one or more keyword search results and the one or more semantic search results, and provide, for display, the combination search results according to the ranking.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order. Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently described systems or methods, their components, acts, or elements to single or plural configurations. References to any act or element being based on any information, act or element may include implementations where the act or element is based at least in part on any information, act, or element.

Any implementation described herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations described herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the described elements and operations without departing from the scope of the technical solutions described herein.

References to “approximately,” “substantially”, or other terms of degree include variations of +/-10% from the given measurement, unit, or range unless explicitly indicated otherwise. Coupled elements can be electrically, mechanically, or physically coupled with one another directly or with intervening elements. Scope of the Systems and methods described herein is thus indicated by the appended claims, rather than the foregoing description, and changes that come within the meaning and range of equivalency of the claims are embraced therein.

What is claimed is:

1. A system, comprising:
one or more processors, coupled with memory, to:
identify one or more terms of a search query input into a user interface of a device;
generate, for display in the user interface using a keyword search, one or more keyword search results based on the one or more terms;
determine that a number of the one or more keyword search results is less than or equal to a threshold for results to display in the user interface:
determine responsive of the number of the one or more keyword search results being less than or equal to the threshold to use a semantic search that is different from the keyword search;
generate, responsive to the determination and using the semantic search for a vector representation of the one or more terms and vector representations of contents to assist with the search query, one or more semantic search results; and
provide, for display via the user interface of the device, a combination of at least one of the one or more of the keyword search results and at least one of the one or more of the semantic search results, wherein a number of results in the combination satisfies the threshold.

2. The system of claim 1 wherein the one or more processors determine that the number of the one or more keyword search results does not satisfy the threshold based on a comparison of the number of the one or more keyword search results and a number of results of the combination.

3. The system of claim 1, wherein a parameter corresponds to a level of quality of the one or more keyword search results, the level of quality determined based on a similarity search between the one or more terms and the one or more keyword search results, and wherein the one or more processors determine that the number of the one or more keyword search results having the level of quality does not satisfy the threshold based on a comparison.

4. The system of claim 1, wherein the one or more processors:
identify one or more machine learning models trained to generate vector representations of summaries of the contents to assist with search queries;
generate, using the contents to assist input into the one or more machine learning models, data structures of summaries of the contents to assist; and
generate, using the data structures input into the one or more machine learning models, vector representations of the contents to assist.

5. The system of claim 4, wherein the contents to assist include at least one of a web page associated with one or more services to be provided via the user interface or a document associated with the one or more services to be provided via the user interface and wherein the data structures include one or more JavaScript Object Notation (JSON) data structures.

6. The system of claim 1, wherein the one or more processors:
receive, via a first portion of the user interface, a first term of the one or more terms of the search query prior to receiving a second term of the one or more terms;
generate, for display in a second portion of the user interface, prior to receiving the second term via the user interface, the one or more keyword search results based on the first term of the one or more terms; and
provide, for display via the second portion of the user interface, prior to receiving the second term via the user interface and based on the first term, the combination of the at least one of the one or more of the keyword search results and the at least one of the one or more of the semantic search results.

7. The system of claim 6, the one or more processors:
receive, via the first portion of the user interface, the second term of the search query;
generate, for display in the second portion of the user interface, the one or more keyword search results based on the first term and the second term; and
provide, for display via the second portion of the user interface based on the first term and the second term, the combination of the at least one of the one or more of the keyword search results and the at least one of the one or more of the semantic search results.

8. The system of claim 1, the one or more processors: determine a difference between a predetermined number of search result entries to display and the number of keyword search results generated using the keyword search;
select, from the one or more semantic search results, a number of semantic search results to compensate for the difference; and
generate the combination to include the number of keyword search results and the number of semantic search results into the predetermined number of search result to satisfy the threshold.

9. The system of claim 1, the one or more processors:
receive, via the user interface, a new term to combine with the one or more terms of the search query into an updated one or more terms; and
generate, for display in the user interface using the keyword search, an updated one or more keyword search results generated based on the updated one or more terms.

10. The system of claim 9, the one or more processors:
determine that an updated parameter of the updated one or more keyword search results satisfies the threshold for results to display in the user interface; and
determine, in response to the updated parameter satisfying the threshold, to provide for display via the user interface of the device, the updated one or more keyword search results instead of the combination.

11. The system of claim 9, the one or more processors:determine to use the semantic search responsive to an updated parameter of the updated one or more keyword search results not satisfying the threshold for results to display in the user interface;
generate, responsive to the updated parameter of the one or more keyword search results not satisfying the threshold and using the semantic search for an updated vector representation of the updated one or more terms and the vector representations of contents to assist with the search query, one or more updated semantic search results; and
provide, for display via the user interface of the device, an updated combination of at least one of the updated one or more of the keyword search results and at least one of the updated one or more of the semantic search results, wherein the updated parameter of the updated combination satisfies the threshold.

12. The system of claim 1, the one or more processors: determine a weighting parameter according to a length of the search query;
select, from the one or more keyword search results, based on the weighting parameter, a second number of keyword search results to include in the combination; and
select, from the one or more semantic search results, based on the second number of keyword search results and the number of the one or more keyword search results , a number of the one or more semantic search results to include in the combination.

13. The system of claim 12, the one or more processors: receive a new term of the one or more terms of the search query;determine an updated weighting parameter according to an updated length of the search query comprising the new term;
select, from the one or more keyword search results and based on the updated weighting parameter, an updated number of keyword search results to include into the combination; and
select, from the one or more semantic search results based on the updated number of keyword search results and the parameter, an updated number of the one or more semantic search results to include into the combination.

14. The system of claim 1, comprising the one or more processors to:
adjust a weighting parameter for at least one of the keyword search results or the semantic search results based on a length of the search query; and
adjust, using the weighting parameter, priority of the one or more semantic search results.

15. The system of claim 1, the one or more processors:
generate, responsive to the determination and based on the one or more terms, the vector representation of the one or more terms; and
generate the one or more semantic search results based on a similarity search between the vector representation of the one or more terms and vector representations of contents to assist with the search query.

16. The system of claim 15, wherein the contents to assist include materials associated with at least one of an application or a document to provide via links in search result entries to display in response to the search query.

17. The system of claim 1, the one or more processors to:
identify a search history of an electronic account associated with the device;
rank, based on the search history, the one or more keyword search results, and the one or more semantic search results; and
provide, for display, the combination according to the ranking.

18. A method, comprising:
identifying, by one or more processors coupled with memory, one or more terms of a search query input into a user interface of a device;
generating, by the one or more processors, for display in the user interface using a keyword search, one or more keyword search results based on the one or more terms;
determining, by the one or more processors, that a number of the one or more keyword search results is less than or equal to a threshold for results to display in the user interface;
determining, by the one or more processors, responsive to aa number of the one or more keyword search results being less than or equal to the threshold to use a semantic search that is different from the keyword search;
generating, by the one or more processors, responsive to the determination and using the semantic search for a vector representation of the one or more terms and vector representations of contents to assist with the search query, one or more semantic search results; and
providing, by the one or more processors, for display via the user interface of the device, a combination of at least one of the one or more of the keyword search results and at least one of the one or more of the semantic search results, wherein a number of results in the combination satisfies the threshold.

19. The method of claim 18, comprising:
receiving, by the one or more processors, via a first portion of the user interface for receiving the search query, a first term of the one or more terms of the search query prior to receiving a second term of the one or more terms;
generating, by the one or more processors, for display in a second portion of the user interface for presenting contents to assist, prior to receiving the second term via the user interface, the one or more keyword search results based on the first term of the one or more terms; and
providing, by the one or more processors, for display via the second portion of the user interface, prior to receiving the second term via the user interface and based on the first term, the combination of the at least one of the one or more of the keyword search results and the at least one of the one or more of the semantic search results.

20. A non-transitory computer-readable medium comprising instructions that, when executed by one or more processors coupled with memory, cause the one or more processors to:
identify one or more terms of a search query input into a user interface of a device;
generate, for display in the user interface using a keyword search, one or more keyword search results based on the one or more terms;
determine that a number of the one or more keyword search results is less than or equal to a threshold for results to display in the user interface;
determine, responsive to the number of the one or more keyword search results being less than or equal to the threshold, to use a semantic search that is different from the keyword search;
generate, responsive to the determination and using the semantic search for a vector representation of the one or more terms and vector representations of contents to assist with the search query, one or more semantic search results; and
provide, for display via the user interface of the device, a combination of at least one of the one or more of the keyword search results and at least one of the one or more of the semantic search results, wherein a number of results in the combination satisfies the threshold.
